(19) United States
(12) Patent Application Publication
(10) Pub. No.: US 2022/0252421 A1
(43) Pub. Date: Aug. 11, 2022

(54) VEHICLE CONTROL DEVICE, VEHICLE CONTROL METHOD, AND STORAGE MEDIUM

(71) Applicant: HONDA MOTOR CO., LTD., Minato-ku, Tokyo (JP)

(72) Inventor: Misa Komuro, Wako-shi (JP)

(21) Appl. No.: 17/624,583

(22) PCT Filed: Jul. 9, 2019
(86) PCT No.: PCT/JP2019/027145

§ 371 Date: Jan. 4, 2022

(51) Int. Cl. G01C 21/00; G01C 21/36

(52) U.S. Cl. CPC G01C 21/3841; G01C 21/36

(57) ABSTRACT

A vehicle control device includes a recognizer that recognizes a surrounding situation of a vehicle, and a map generator that generates local map information associated with a user on the basis of the surrounding situation recognized by the recognizer and an instruction of the user regarding whether or not a map for each route or road through which the vehicle passes is generated.

### TECHNICAL FIELD

The present invention relates to a vehicle control device, a vehicle control method, and a program.

### BACKGROUND ART

In the related art, a technology for creating a position information database of a vehicle by acquiring position information while the vehicle is traveling, and displaying, for example, movement information of a vehicle visiting a certain facility by superimposing the movement information on map information is known. This technology makes it possible to allow visual recognition of movement information with respect to roads with a large number of vehicles, and makes it difficult to visually recognize movement information of vehicles with respect to roads with a small number of vehicles so that a movement route of a specific vehicle that has passed along a road with a small number of vehicles is ascertained, thereby protecting personal information (for example, Patent Document 1).

### CITATION LIST

### Patent Document

### [Patent Document 1]

Japanese Unexamined Patent Application, First Publication No. 2018-169914

### SUMMARY OF INVENTION

### Technical Problem

The related art is to create a map on the basis of movement information of vehicles while considering personal information, but since all of the movement information of vehicles are collected, in certain cases the related art does not sufficiently consider personal information since the related art does not handle a desire of individual occupants not wanting movement information for a specific road on a route along which a vehicle has passed to be collected. Further, the map created by the related art is created on the basis of movement information of a large number of vehicles, and it is not possible to create a map associated with individuals based on movement information of each vehicle.

The present invention has been made in consideration of such circumstances, and an object of the present invention is to provide a vehicle control device, a vehicle control method, and a program capable of generating map information associated with an individual in an arbitrary range.

### Solution to Problem

A vehicle control device, a vehicle control method, and a program according to the present invention have the following configurations.

(1) A vehicle control device according to an aspect of the present invention includes: a recognizer configured to recognize a surrounding situation of a vehicle; and a map generator configured to generate local map information associated with a user on the basis of the surrounding situation recognized by the recognizer and an instruction of the user regarding whether or not a map for each route or road through which the vehicle passes is generated.

In aspect (2), the vehicle control device according to aspect (1) further includes: a map updater configured to delete, from the local map information, information indicating at least some routes or roads designated by the user among the routes or roads indicated by the local map information generated by the map generator.

In aspect (3), the vehicle control device according to aspect (1) further includes: a controller configured to perform control using the local map information on the basis of an instruction of the user regarding availability of the local map information generated by the map generator.

In aspect (4), in the vehicle control device according to aspect (1), the map generator changes whether or not the local map information is generated on the basis of the presence or absence of passengers in the vehicle.

In aspect (5), in the vehicle control device according to aspect (3), the controller changes whether or not control using the local map information is performed on the basis of the presence or absence of passengers in the vehicle.

In aspect (6), the vehicle control device according to aspect (1) further includes: a provider configured to provide route information with which the local map information is scheduled to be generated after the vehicle ends traveling.

In aspect (7), in the vehicle control device according to aspect (1), the map generator does not generate the local map information of the vicinity of a home of the user.

In aspect (8), the vehicle control device according to aspect (1) further includes: a screen generator configured to generate a screen capable of receiving a designation of a route or road for which the local map information is not generated.

In aspect (9), the vehicle control device according to aspect (1) further includes: a screen generator configured to generate a screen capable of receiving a designation of the route or road to be deleted among the routes or roads indicated by the local map information.

(10) A vehicle control method of another aspect of the present invention includes: recognizing, by a computer, a surrounding situation of a vehicle; and generating, by the computer, local map information associated with a user on the basis of the recognized surrounding situation and an instruction of the user regarding whether or not a map for each route or road through which the vehicle passes is generated.

(11) A program of another aspect of the present invention causes a computer to: recognize a surrounding situation of a vehicle; and generate local map information associated with a user on the basis of the recognized surrounding situation and an instruction of the user regarding whether or not a map for each route or road through which the vehicle passes is generated.

### Advantageous Effects of Invention

According to (1) to (11), it is possible to generate the map information associated with an individual in an arbitrary range.

According to (2), (6), (7), (8), and (9), it is possible to limit generation of created map information or delete the map information later, to generate map information according to desire of each user, and to improve convenience.

According to (3), it is possible to select whether or not created map information is used, to provide a method of using the map information according to desire of each user, and to improve convenience.

According to (4) and (5), it is possible to provide a method of using map information according to desire of each user and improve convenience by making generation or use of map information variable depending on the presence or absence of passengers.

### BRIEF DESCRIPTION OF DRAWINGS

FIG. 1 is a configuration diagram of a vehicle system 1 using a vehicle control device 100 of an embodiment.

FIG. 2 is a functional configuration diagram of a first controller 120 and a second controller 160.

FIG. 3 is a diagram for explaining a traveling environment of the vehicle M.

FIG. 4 is a diagram showing an example of a setting screen for exclusion information 186.

FIG. 5 is a diagram showing an example of the exclusion information 186.

FIG. 6 is a diagram showing another example of the setting screen for the exclusion information 186.

FIG. 7 is a diagram showing another example of the exclusion information 186.

FIG. 8 is a flowchart showing an example of a process of generating local map information 182 in the vehicle control device 100.

FIG. 9 is a diagram showing an example of a deletion screen for the local map information 182.

FIG. 10 is a diagram showing another example of the deletion screen for the local map information 182.

FIG. 11 is a diagram showing an example of a confirmation screen for the local map information 182.

FIG. 12 is a diagram showing an example of availability information 188.

FIG. 13 is a flowchart showing an example of a process using the local map information 182 in the vehicle control device 100.

FIG. 14 is a diagram showing an example of hardware configurations of various control devices.

### DESCRIPTION OF EMBODIMENTS

Hereinafter, embodiments of a vehicle control device, a vehicle control method, and a program of the present invention will be described with reference to the drawings. The vehicle control device of the embodiment is applied to, for example, an automated driving vehicle. Automated driving is, for example, to execute driving control by controlling one or both of steering and acceleration/deceleration of a vehicle. The above-described driving control includes, for example, driving control such as adaptive cruise control system (ACC), traffic jam pilot (TJP), auto lane changing (ALC), collision mitigation brake system (CMBS), and lane keeping assistance system (LKAS). Further, in an automated driving vehicle, driving control based on manual driving of an occupant (driver) may be executed.

### First Embodiment

### [Overall Configuration]

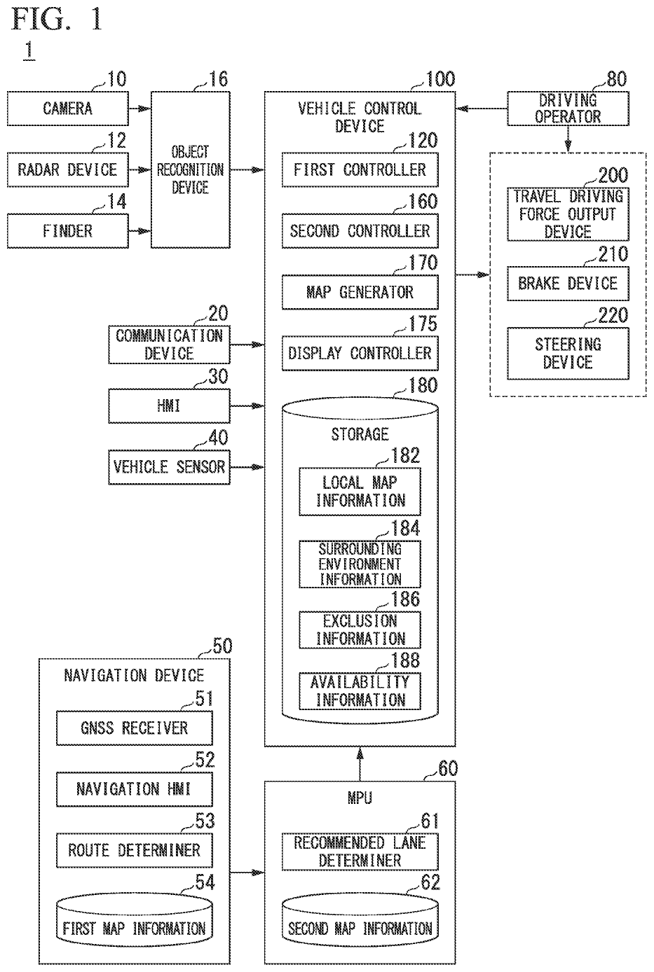

FIG. 1 is a configuration diagram of a vehicle system 1 using a vehicle control device 100 of a first embodiment. A vehicle in which the vehicle system 1 is mounted is, for example, a vehicle such as a two-wheeled vehicle, a three-wheeled vehicle, or a four-wheeled vehicle, and a driving source thereof includes an internal combustion engine such as a diesel engine or a gasoline engine, an electric motor, or a combination thereof. The electric motor operates using power generated by a power generator connected to the internal combustion engine or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, the vehicle control device 100, a travel driving force output device 200, a brake device 210, and a steering device 220. These devices or equipment are connected to each other by a multiplex communication line such as a controller area network (CAN) communication line, a serial communication line, a wireless communication network, or the like. The configuration shown in FIG. 1 is merely an example, and a part of the configuration may be omitted or other constituents may be added thereto.

The camera 10 is, for example, a digital camera using a solid-state imaging device such as a charge coupled device (CCD) or a complementary metal oxide semiconductor (CMOS). The camera 10 is attached to any place of a vehicle (hereinafter, vehicle M) on which the vehicle system 1 is mounted. In the case of forward imaging, the camera 10 is attached to, for example, an upper portion of a front windshield, a rear surface of a rearview mirror, or the like. The camera 10, for example, periodically and repeatedly images surroundings of the vehicle M. The camera 10 may be a stereo camera.

The radar device 12 radiates radio waves such as millimeter waves to the surroundings of the vehicle M and detects radio waves (reflected waves) reflected by an object to detect at least a position (a distance and orientation) of the object. The radar device 12 is attached to any place on the vehicle M. The radar device 12 may detect a position and a speed of the object using a frequency modulated continuous wave (FM-CW) scheme.

The finder 14 is a light detection and ranging (LIDAR) finder. The finder 14 radiates light to the surroundings of the vehicle M and measures scattered light. The finder 14 detects the distance to a target on the basis of a time from light emission to light reception. The radiated light is, for example, pulsed laser light. The finder 14 is attached to any place on the vehicle M.

The object recognition device 16 performs a sensor fusion process on detection results of some or all of the camera 10, the radar device 12, and the finder 14 to recognize a position, type, speed, and the like of the object. The object recognition device 16 outputs recognition results to the vehicle control device 100. The object recognition device 16 may output the detection results of the camera 10, the radar device 12, and the finder 14 as they are to the vehicle control device 100. The object recognition device 16 may be omitted from the vehicle system 1.

The communication device 20, for example, communicates with another vehicle present around the automated driving vehicle using a cellular network, a Wi-Fi network, Bluetooth (registered trademark), dedicated short range communication (DSRC), or the like or communicates with various server devices via a wireless base station.

The HMI 30 presents various types of information to an occupant of the automated driving vehicle and receives an input operation from the occupant. The HMI 30 includes various display devices, speakers, buzzers, a touch panel, switches, keys, and the like. The HMI 30 is an example of an “interface device”.

The vehicle sensor 40 includes, for example, a vehicle speed sensor that detects a speed of the automated driving vehicle, an acceleration sensor that detects an acceleration, a yaw rate sensor that detects an angular speed around a vertical axis, and an orientation sensor that detects a direction of the automated driving vehicle.

The navigation device 50 includes, for example, a GNSS receiver 51, a navigation HMI 52, and a route determiner 53. The navigation device 50 holds first map information 54 in a storage device such as an HDD or a flash memory. The GNSS receiver 51 specifies a position of the automated driving vehicle on the basis of a signal received from a GNSS satellite. The position of the automated driving vehicle may be specified or corrected by an inertial navigation system (INS) using an output of the vehicle sensor 40. The navigation HMI 52 includes a display device, a speaker, a touch panel, keys, and the like. The navigation HMI 52 may be partly or wholly shared with the HMI 30 described above. The route determiner 53, for example, determines a route (hereinafter, an on-map route) from the position of the automated driving vehicle specified by the GNSS receiver 51 (or any input position) to a destination input by the occupant using the navigation HMI 52 by referring to the first map information 54.

The first map information 54 is, for example, information in which a road shape is represented by links indicating roads and nodes connected by the links. The first map information 54 may include a curvature of the road, point of interest (POI) information, and the like. The on-map route is output to the MPU 60. The navigation device 50 may perform route guidance using the navigation HMI 52 on the basis of the on-map route. The navigation device 50 may be realized, for example, by a function of a terminal device such as a smartphone or a tablet terminal possessed by the occupant. The navigation device 50 may transmit a current position and a destination to a navigation server via the communication device 20 and acquire the same route as the on-map route from the navigation server.

The MPU 60 includes, for example, a recommended lane determiner 61, and holds second map information 62 in a storage device such as an HDD or a flash memory. The recommended lane determiner 61 divides the on-map route provided from the navigation device 50 into a plurality of blocks (for example, divides the route every 100 [m] in a traveling direction of the vehicle), and determines a recommended lane for each block by referring to the second map information 62. The recommended lane determiner 61 determines in which lane from the left the automated driving vehicle travels. The recommended lane determiner 61 determines the recommended lane so that the automated driving vehicle can travel on a reasonable route for travel to a branch destination when there is a branch place in the on-map route.

The second map information 62 is map information with higher accuracy than the first map information 54. The second map information 62 includes, for example, information on a center of the lane or information on a boundary of the lane. Further, the second map information 62 may include road information, traffic regulation information, address information (an address and postal code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a variant steering wheel, a joystick, and other operators. A sensor that detects the amount of operation or the presence or absence of the operation is attached to the driving operator 80, and a detection result thereof is output to the vehicle control device 100 or some or all of the travel driving force output device 200, the brake device 210, and the steering device 220.

The vehicle control device 100 includes, for example, a first controller 120, a second controller 160, a map generator 170 (a map generator or map updater), a display controller 175 (a provider or screen generator), and a storage 180. The first controller 120, the second controller 160, the map generator 170, and the display controller 175 are realized, for example, by a hardware processor such as a central processing unit (CPU) executing a program (software). Further, some or all of these components may be realized by hardware (circuit portion; including circuitry) such as an LSI, an ASIC, an FPGA, or a GPU, or may be realized by software and hardware in cooperation. The program may be stored in a storage device (a storage device including a non-transient storage medium) such as an HDD or a flash memory in advance, or may be stored in a removable storage medium (a non-transient storage medium) such as a DVD or a CD-ROM and installed in the HDD or flash memory of the vehicle control device 100 by the storage medium (the non-transient storage medium) being mounted in a drive device.

The storage 180 is realized by, for example, a hard disk drive (HDD), a flash memory, an electrically erasable programmable read-only memory (EEPROM), a read only memory (ROM), or a random-access memory (RAM). The storage 180 stores, for example, the local map information 182, surrounding environment information 184, the exclusion information 186, availability information 188, and other information.

The local map information 182 is map information generated on the basis of information collected when the vehicle M is traveling, and is high-performance map information equivalent to the second map information. The local map information 182 may be referred to as an “experience map” or a “user map”. The local map information 182 is associated with a driver of the vehicle M and stored in the storage 180. The local map information 182 includes, for example, information on a center of a lane, information on a boundary of the lane, and the like. Content of the surrounding environment information 184, the exclusion information 186, and the availability information 188 will be described below.

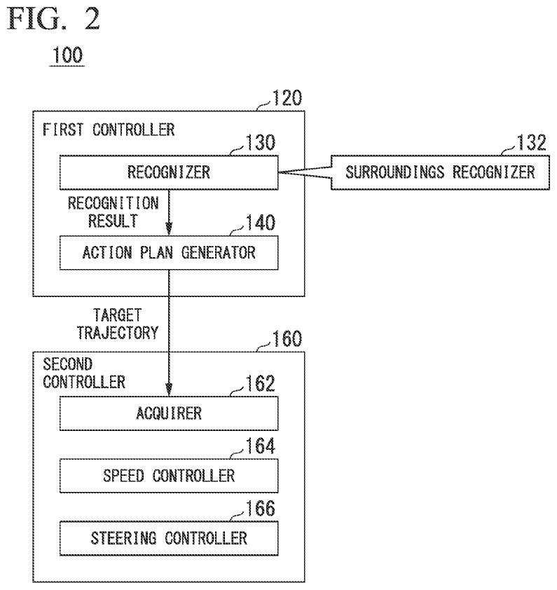

FIG. 2 is a functional configuration diagram of the first controller 120 and the second controller 160. The first controller 120 includes, for example, a recognizer 130 and an action plan generator (controller) 140. The first controller 120 realizes, for example, a function using artificial intelligence (AI) and a function using a previously given model in parallel. For example, a function of “recognizing an intersection” may be realized by recognition of an intersection using deep learning or the like and recognition on the basis of previously given conditions (there is a signal which can be subjected to pattern matching, a road sign, or the like) being executed in parallel and scored for comprehensive evaluation. Accordingly, the reliability of automated driving is ensured.

The recognizer 130 recognizes surroundings of the vehicle M and estimates a behavior of an object to be recognized. The recognizer 130 includes, for example, a surroundings recognizer 132.

The surroundings recognizer 132 recognizes states such as a position, speed, and acceleration of an object (such as a preceding vehicle or an oncoming vehicle) near the automated driving vehicle on the basis of information input from the camera 10, the radar device 12, and the finder 14 via the object recognition device 16. The position of the object is recognized as, for example, a position on absolute coordinates with a representative point (a centroid, a center of a drive axis, or the like) of the automated driving vehicle as an origin, and is used for control. The position of the object may be represented by a representative point such as the centroid or a corner of the object, or may be represented by a represented area. A “state” of an object may include an acceleration or jerk of the object, or a “behavioral state” (for example, whether or not a preceding vehicle of the vehicle M is changing lanes or is about to change lanes).

When the surroundings recognizer 132 recognizes a traveling lane, the surroundings recognizer 132 recognizes a position or posture of the automated driving vehicle with respect to the traveling lane. The surroundings recognizer 132 may recognize, for example, a deviation of a reference point of the automated driving vehicle from a center of the lane and an angle formed between a traveling direction of the automated driving vehicle and a line connecting along the center of the lane as a relative position and posture of the automated driving vehicle with respect to the traveling lane. In addition or instead, the surroundings recognizer 132 may recognize, for example, a position of the reference point of the automated driving vehicle with respect to any one of side end portions (a road demarcation line or a road boundary) of the traveling lane as the relative position of the automated driving vehicle with respect to the traveling lane.

Further, the surroundings recognizer 132, for example, recognizes a lane (a traveling lane) in which the automated driving vehicle is traveling. For example, the surroundings recognizer 132 compares a pattern of road demarcation lines (for example, an arrangement of solid lines and broken lines) obtained from the second map information 62 with a pattern of road demarcation lines around the automated driving vehicle recognized from an image captured by the camera 10 to recognize the traveling lane. The surroundings recognizer 132 may recognize not only the road demarcation lines but also a traveling road boundary (road boundary) including road demarcation lines, a road shoulder, a curb, a median strip, a guard rail, or the like to recognize the traveling lane. In this recognition, the position of the automated driving vehicle acquired from the navigation device 50 or a processing result of an INS may be additionally considered. The surroundings recognizer 132 recognizes a temporary stop line, a signal, and other road events.

The surroundings recognizer 132 recognizes information on a roadway on which a surrounding vehicle, particularly, the vehicle M is scheduled to travel on the basis of a vehicle around the vehicle M recognized from the image captured by the camera 10, the image captured by the camera 10, traffic congestion information of the vicinity of the vehicle M acquired by the navigation device 50, or position information obtained from the second map information 62. The information on the roadway on which the vehicle M is scheduled to travel includes, for example, a lane width (roadway width) of lane on which the vehicle M is scheduled to travel.

The surroundings recognizer 132 recognizes, for example, the surrounding environment so that the local map information 182 can be generated in the area in which the second map information 62 does not exist. The surroundings recognizer 132, for example, compares the first map information 54 with a pattern of a road demarcation line around the automated driving vehicle recognized from an image captured by the camera 10 to recognize the traveling lane. The surroundings recognizer 132 may recognize not only the road demarcation lines but also a traveling road boundary (a road boundary) including the road demarcation lines, a road shoulder, a curb, a median strip, a guard rail, or the like to recognize the traveling lane. Further, the surroundings recognizer 132 recognizes a temporary stop line, a signal, and other road events. The surroundings recognizer 132 stores a part or all of a recognition result in the storage 180 as the surrounding environment information 184.

In principle, the action plan generator 140 generates a target trajectory along which the vehicle M will travel in the future so that the vehicle M travels on the recommended lane determined by the recommended lane determiner 61 and automated driving applicable to a surroundings situation of the vehicle M is executed. The target trajectory includes, for example, a speed element. For example, the target trajectory is represented as a sequence of points (trajectory points) to be reached by the vehicle M. The trajectory point is a point that the vehicle M is to reach for each predetermined travel distance (for example, several meters) at a road distance, and a target speed and a target acceleration at every predetermined sampling time (for example, every several tenths of a [sec]) are separately generated as a part of the target trajectory.

The action plan generator 140 causes the recommended lane determiner 61 to determine the recommended lane by using information comparable to high-accuracy map information stored in the local map information 182 in the storage 180 in the area in which the second map information 62 does not exist. The action plan generator 140 generates the target trajectory along which the vehicle M will travel in the future so that the vehicle M travels on the recommended lane determined by the recommended lane determiner 61 and automated driving applicable to a surroundings situation of the vehicle M is executed.

For example, the navigation HMI 52 of the navigation device 50 receives an input of information on a destination when an occupant such as a driver of the vehicle M gets on the vehicle. The navigation device 50 determines a route (target trajectory) on a map from a current location of the vehicle M to the received destination. This route on the map is stored in the navigation device 50 until the destination is reached. In this case, the action plan generator 140 may select a driving state to be executed on the route in advance. Further, the action plan generator 140 may select a suitable driving state at any time on the basis of a result of the surroundings recognizer 132 recognizing the image captured by the camera 10 or the like during traveling.

The second controller 160 controls the travel driving force output device 200, the brake device 210, and the steering device 220 so that the automated driving vehicle passes through the target trajectory generated by the action plan generator 140 at a scheduled time.

The second controller 160 includes, for example, an acquirer 162, a speed controller 164, and a steering controller 166. The acquirer 162 acquires information on the target trajectory (trajectory points) generated by the action plan generator 140 and stores the information on the target trajectory in a memory (not shown). The speed controller 164 controls the travel driving force output device 200 or the brake device 210 on the basis of the speed element included in the target trajectory stored in the memory. The steering controller 166 controls the steering device 220 according to a degree of bending of the target trajectory stored in the memory. Processes of the speed controller 164 and the steering controller 166 are realized by, for example, a combination of feedforward control and feedback control. For example, the steering controller 166 executes a combination of feedforward control according to a curvature of a road in front of the automated driving vehicle and feedback control on the basis of a deviation from the target trajectory.

Referring back to FIG. 1, the map generator 170 generates or updates the local map information 182 on the basis of the surrounding environment information 184 (recognition results of the surroundings recognizer 132) stored in the storage 180. Accordingly, the local map information 182, which is new map information not included in the second map information 62, is generated. That is, the map generator 170 generates the local map information 182 associated with the user on the basis of the surrounding situation recognized by the surroundings recognizer 132 and an instruction of the user regarding whether or not a map is generated for each route or road through which the vehicle M passes. Further, the map generator 170 (map updater) deletes, from the local map information 182, information indicating at least some routes or roads designated by the user among the routes or roads indicated by the generated local map information 182.

The display controller 175 provides the driver with information necessary for generation or updating of the local map information 182, and generates a screen capable of receiving an input of an instructions from the driver. The display controller 175 causes the HMI 30 to display the generated screen, for example. The display controller 175 generates a screen capable of receiving a designation of a route or a road for which the local map information 182 is not generated. The display controller 175 generates a screen capable of receiving a designation of a route or road to be deleted among the routes or roads indicated by the local map information 182. Details of a function of the display controller 175 will be described below.

The travel driving force output device 200 outputs a travel driving force (torque) for traveling of the vehicle to driving wheels. The travel driving force output device 200 includes, for example, a combination of an internal combustion engine, an electric motor, a transmission, and the like, and an electronic control unit (ECU) that controls these. The ECU controls the above configuration according to information input from the second controller 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second controller 160 or information input from the driving operator 80 so that a brake torque according to a braking operation is output to each wheel. The brake device 210 may include a mechanism that transfers the hydraulic pressure generated by an operation of the brake pedal included in the driving operator 80 to the cylinder via a master cylinder, as a backup. The brake device 210 is not limited to the configuration described above and may be an electronically controlled hydraulic brake device that controls an actuator according to information input from the second controller 160 and transfers the hydraulic pressure of the master cylinder to the cylinder.

The steering device 220 includes, for example, a steering ECU and an electric motor. The electric motor, for example, changes directions of steerable wheels by causing a force to act on a rack and pinion mechanism. The steering ECU drives the electric motor according to information input from the second controller 160 or information input from the driving operator 80 to change the directions of the steerable wheels.

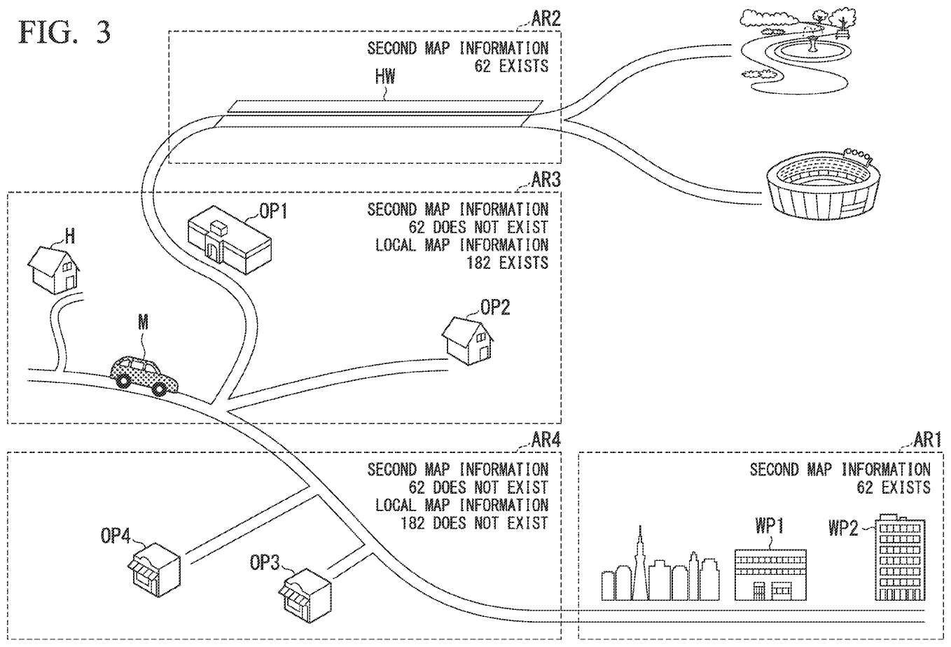

FIG. 3 is a diagram for explaining a traveling environment of the vehicle M. The second controller 160 of the vehicle M controls the target trajectory generated by the action plan generator 140 on the basis of the second map information 62 so that the automated driving vehicle passes along the target trajectory in a case in which a workplace WP1 and a workplace WP2 present in an area AR1 in which the second map information 62 exists are destinations, or a case in which the vehicle is traveling on a highway HW present in an area AR2 in which the second map information 62 exists.

On the other hand, when the vicinity of a home H present in an area AR3 in which the second map information 62 does not exist and the local map information 182 exists, a destination OP1 and a destination OP2 (for example, a supermarket, a hospital, a friend, or a relative's house) which the automated driving vehicle regularly visits, or the like is a destination, the second controller 160 performs control so that the automated driving vehicle passes along a target trajectory generated by the action plan generator 140 on the basis of the local map information 182.

On the other hand, when a destination OP3, a destination OP4, or the like present in an area AR4 in which the second map information 62 does not exist and the local map information 182 does not exist is a destination, the action plan generator 140 cannot generate the target trajectory and thus the second controller 160 cannot perform automated driving control. In this case, in the vehicle M, driving control based on manual driving of the driver is required. While driving control based on manual driving of the driver is being executed, recognition of the surrounding environment is performed by the surroundings recognizer 132 and results of the recognition are stored in the storage 180 as the surrounding environment information 184.

The map generator 170 generates the local map information 182 for the area AR4 on the basis of the surrounding environment information 184 stored in the storage 180 as described above. When the map generator 170 generates the local map information 182 for the area AR4, the second controller 160 performs control so that the automated driving vehicle passes along the target trajectory generated by the action plan generator 140 on the basis of the newly generated local map information 182.

### [Operation Flow]

Next, the process of generating the local map information 182 in the vehicle control device 100 will be described. In this process of generating the local map information, the local map information 182 is generated on the basis of the surrounding environment information 184 stored in the storage 180 and the exclusion information 186 preset by the driver or the like.

### <Process of Registering Exclusion Information>

First, a process of registering the exclusion information 186 will be described. The exclusion information 186 defines routes, roads, sections, ranges, and the like for which the driver does not want to generate the local map information 182. For example, the driver may operate an exclusion information setting screen displayed on the HMI 30 or the like on the basis of the control of the display controller 175 to set routes, roads, sections, ranges, and the like for which the driver does not want to generate the local map information 182.

### (Route Exclusion)

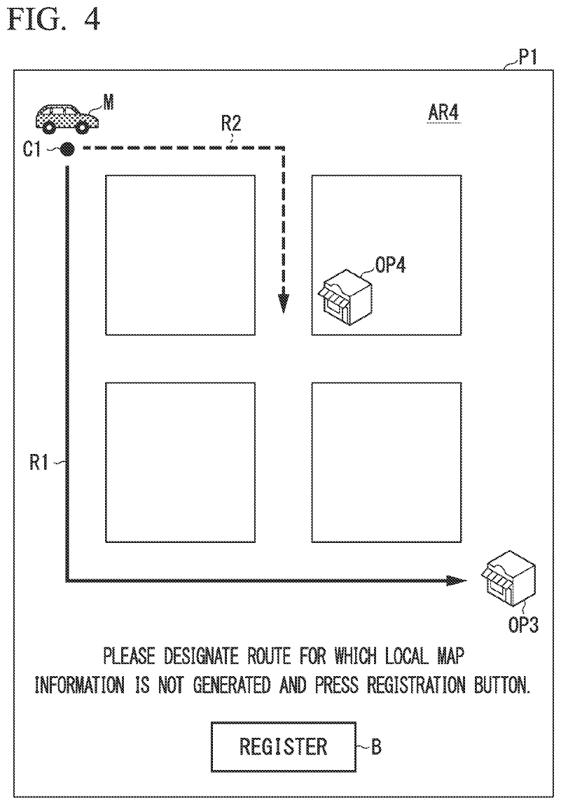

FIG. 4 is a diagram showing an example of a setting screen for exclusion information. In a setting screen P1 shown in FIG. 4, a route R1 from a current point C1 of the vehicle M to the destination OP3 and a route R2 from the current point C1 to the destination OP4 are shown. The driver can designate the route for which the driver does not want to generate the local map information 182 among the two routes R1 and R2 (for example, touch a screen of the HMI 30 that is a touch panel), and press a registration button B to register a route to be excluded in advance. In this example, the route R2 is designated.

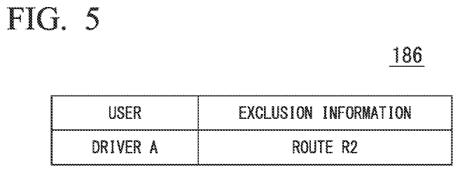

FIG. 5 is a diagram showing an example of the exclusion information 186. In the example shown in FIG. 5, the route R2 is registered as the exclusion information associated with a driver A. When the route R2 is registered in the exclusion information 186, the vehicle control device 100 does not generate the local map information 182 for the route R2.

### (Road Exclusion)

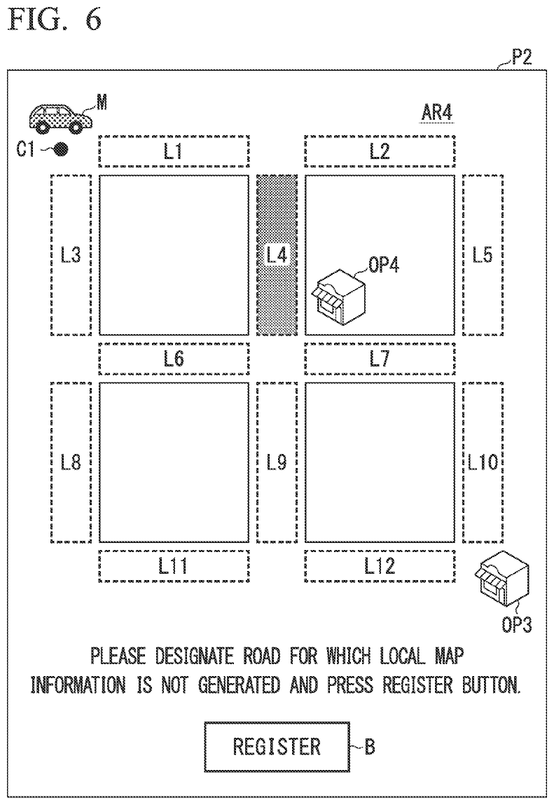

FIG. 6 is a diagram showing another example of a setting screen for the exclusion information 186. In the setting screen P2 shown in FIG. 6, roads L1 to L12 included in a route from the current position C1 of the vehicle M to the destination OP3 and the destination OP4 are shown. The driver can designate the road for which the driver does not want to generate the local map information 182 among the roads L1 to L12 (for example, touch the screen of the HMI 30 which is a touch panel), and press the registration button B to register a road to be excluded in advance. In this example, the road L4 is designated.

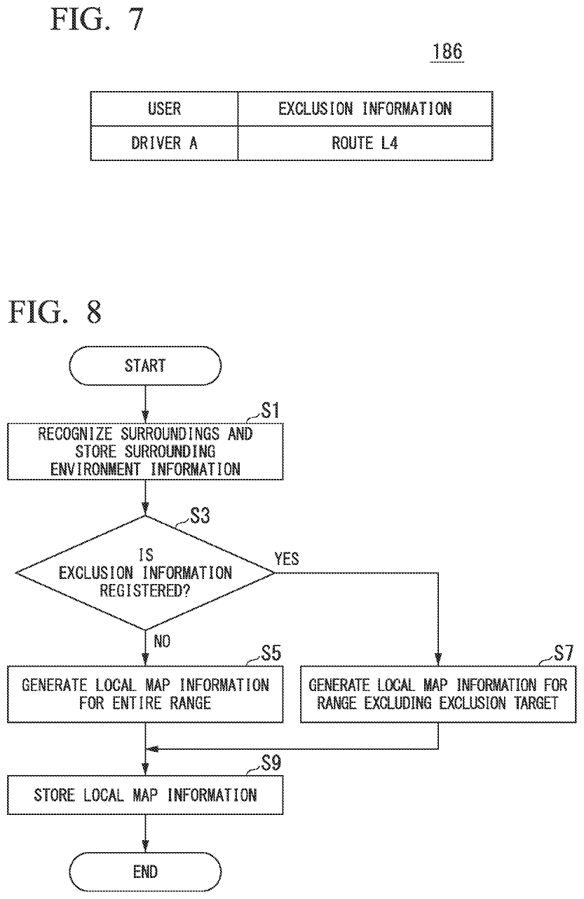

FIG. 7 is a diagram showing another example of the exclusion information 186. In the example shown in FIG. 7, the road L4 is registered as the exclusion information associated with the driver A. When the road L4 is registered in the exclusion information 186, the vehicle control device 100 does not generate the local map information 182 for the road L4.

### <Process of Generating Local Map Information>

Next, a process of generating the local map information 182 will be described. FIG. 8 is a flowchart showing an example of the process of generating the local map information 182 in the vehicle control device 100. The flowchart shown in FIG. 8 is started, for example, when the vehicle M enters an area (for example, the area AR3 and the area AR4 shown in FIG. 3) in which there is no second map information 62.

First, the surroundings recognizer 132 of the vehicle control device 100 recognizes a surrounding environment of the vehicle M, and stores a recognition result as the surrounding environment information 184 in the storage 180 (step S1). The surroundings recognizer 132 recognizes the traveling lane by comparing, for example, the first map information 54 with a pattern of the road demarcation lines around the vehicle M recognized in the image captured by the camera 10. Further, the surroundings recognizer 132 recognizes a temporary stop line, a signal, and other road events.

Then, for example, after the vehicle M arrives at a predetermined destination and ends traveling, the map generator 170 starts generation of the local map information 182 using the surrounding environment information 184. The map generator 170 determines whether or not the exclusion information 186 is registered in the storage 180 (step S3).

When the map generator 170 determines that the exclusion information 186 is not registered, the map generator 170 generates the local map information 182 for an entire range indicated by the surrounding environment information 184 stored in the storage 180 (step S5). The map generator 170 updates the local map information 182 on the basis of the newly acquired surrounding environment information 184 for a range in which the local map information 182 already exists.

On the other hand, when the map generator 170 determines that the exclusion information 186 is registered, the map generator 170 generates the local map information 182 for a range excluding a range (a route, road, section, area, or the like) registered in the exclusion information 186 in the range indicated by the surrounding environment information 184 stored in the storage 180 (step S7). The map generator 170 updates the local map information 182 on the basis of the newly acquired surrounding environment information 184 for the range in which the local map information 182 already exists.

Then, the map generator 170 stores the generated local map information 182 in the storage 180 (step S9). Now, the process of this flowchart ends.

In the above description, a case in which the map generator 170 starts the generation of the local map information 182 after the vehicle M arrives at the predetermined destination and ends traveling has been described as an example, but the present invention is not limited to thereto. For example, the map generator 170 may start the generation of the local map information 182, for example, in a case in which an instruction to generate the local map information 182 is received from the driver via the HMI 30, a case in which a predetermined time interval has passed (or a predetermined time has been reached), or when next traveling start (when an ignition is turned on).

### <Process of Deleting Local Map Information>

### (Route Deletion)

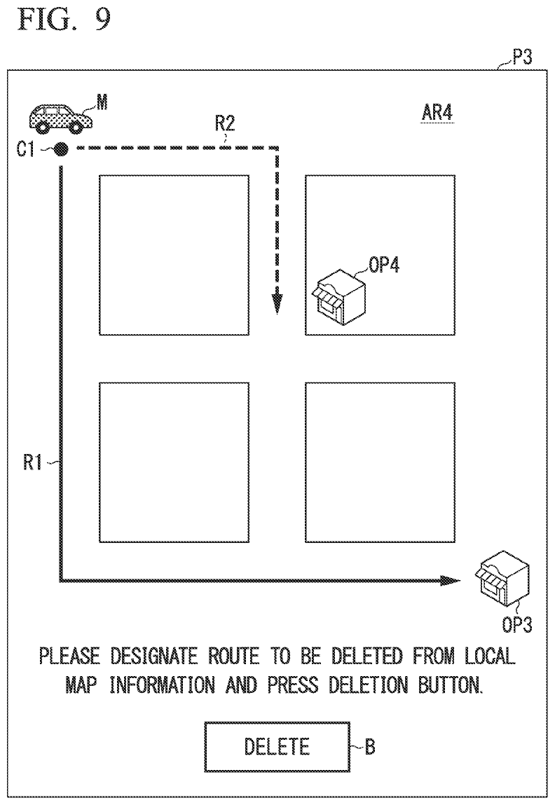

Next, a process of deleting the local map information 182 will be described. The driver can check the generated local map information 182 and delete a part or all of the local map information 182. FIG. 9 is a diagram showing an example of a deletion screen for the local map information 182. In the deletion screen P3 shown in FIG. 9, the created routes R1 and R2 are shown as the local map information 182. The driver can designate the route to be deleted from the local map information 182 among the two routes R1 and R2 (for example, touch the screen of the HMI 30 which is a touch panel), and press the deletion button B to delete local map information on a specific route. In this example, the route R2 is designated.

### (Road Deletion)

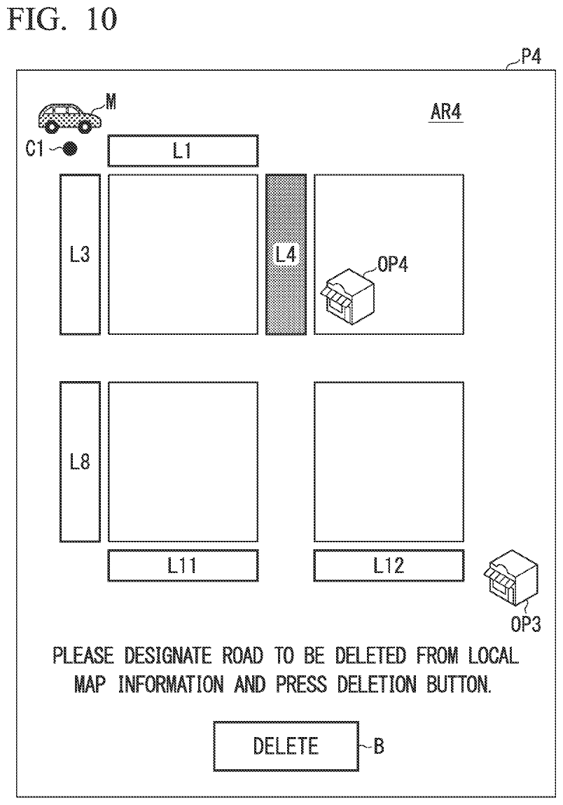

FIG. 10 is a diagram showing another example of the deletion screen for the local map information 182. In the deletion screen P4 shown in FIG. 10, created roads L1, L3, L4, L8, L11, and L12 are shown as local map information 182. The driver can designate the road to be deleted from the local map information 182 among the roads L1, L3, L4, L8, L11, and L12 (for example, touch the screen of the HMI 30 which is a touch panel), and press the deletion button B to delete local map information on a specific road. In this example, the road L4 is designated.

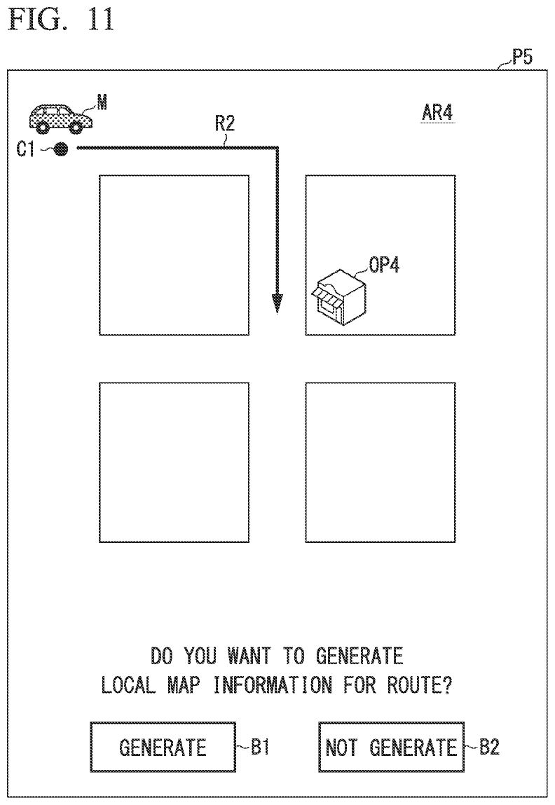

For example, after the vehicle M arrives at the predetermined destination and ends traveling and before the generation of the local map information 182 starts, a screen showing a route, a road, or the like for which the local map information 182 is scheduled to be generated may be presented to the driver and the driver may be allowed to input whether the local map information 182 is to be generated, under control of the display controller 175. FIG. 11 is a diagram showing an example of a confirmation screen for the local map information 182. The route R2 for which the local map information 182 is scheduled to be generated is shown on a confirmation screen P5 shown in FIG. 11. The driver can designate whether or not the local map information 182 is to be generated by selecting one of a “button B1 for generation” and a “button B2” for non-generation shown on the confirmation screen P5. The local map information 182 of some routes (roads) may not be generated by making it possible to receive a designation of only some roads in the route R2. That is, the display controller 175 provides the route information with which the local map information 182 is scheduled to be generated after traveling of the vehicle M ends.

When the vehicle M is used by an unspecified number of users, such as when the vehicle M is a shared vehicle used for a ride sharing service, the map generator 170 may not generate the local map information 182 for the vicinity of a home of each user. Information of the home of each user may be registered in advance by each user via the HMI 30 and stored in the storage 180.

Further, when there is a passenger in the vehicle M, the map generator 170 may not generate the local map information 182. The map generator 170, for example, may confirm the presence or absence of a passenger other than the driver by referring to, for example, an image of a camera provided in the vehicle M, and may not generate the local map information 182 based on the collected surrounding environment information 184 when there is a passenger. That is, the map generator 170 changes whether or not the local map information 182 is generated on the basis of the presence or absence of the passenger in the vehicle M.

### <Process Using Local Map Information>

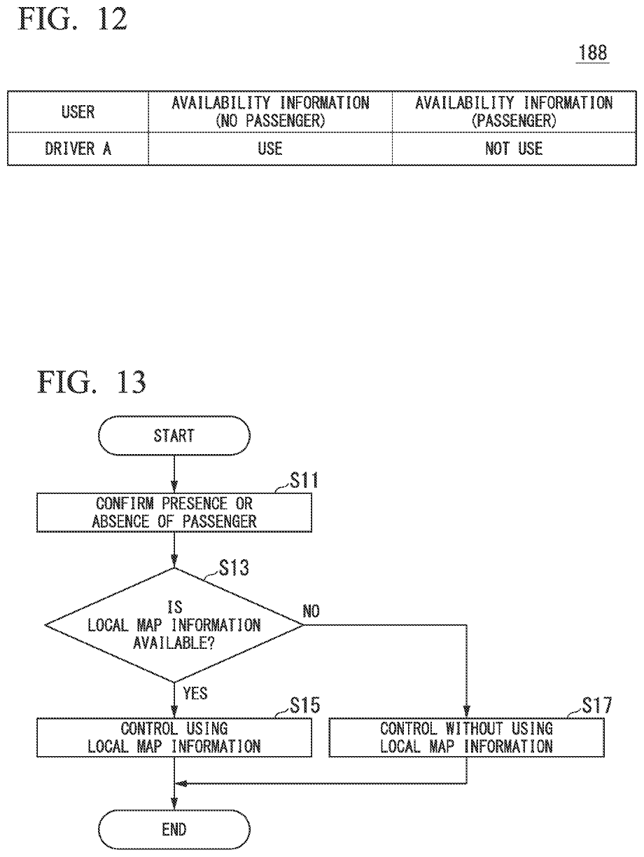

Next, a process using the local map information 182 will be described. The vehicle control device 100 performs control of the process using the local map information 182 on the basis of the availability information 188 preset by the driver and stored in the storage 180. FIG. 12 is a diagram showing an example of the availability information 188. The availability information 188 is associated with information (for example, “use” or “not use”) indicating whether or not the driver uses the local map information 182. It is possible to individually set whether or not the local map information 182 is used in the availability information 188 according to a case in which there is a passenger and a case in which there is no passenger. For example, the driver can set whether or not the generated local map information 182 can be used in advance by operating a setting screen displayed on the HMI 30.

FIG. 13 is a flowchart showing an example of the process using the local map information 182 in the vehicle control device 100. The flowchart shown in FIG. 13 is started, for example, when the vehicle M invades an area (for example, the area AR3 shown in FIG. 3) in which the second map information 62 does not exist and the local map information 182 exists.

First, the first controller 120 of the vehicle control device 100 confirms the presence or absence of a passenger other than the driver by referring to the image of the camera provided in the vehicle M (step S11).

Next, the action plan generator 140 of the vehicle control device 100 refers to the availability information 188 stored in the storage 180 to determine whether or not the local map information 182 is available to the driver (step S13). In the example of the availability information 188 shown in FIG. 12, the use of the local map information 182 is permitted when there is no passenger, and the use of the local map information 182 is not permitted when there is a passenger. Therefore, when it is confirmed that there is no passenger, the action plan generator 140 determines that the local map information 182 is available. On the other hand, when it is confirmed that there is a passenger, the action plan generator 140 determines that the local map information 182 is not available.

When the action plan generator 140 determines that the local map information 182 is available, the action plan generator 140 performs control using the local map information 182 (step S15). For example, when the automated driving control is performed, the action plan generator 140 generates a target trajectory using the local map information 182 and outputs the target trajectory to the second controller 160. Further, the action plan generator 140 causes the HMI 30 to display a detailed map on the basis of the local map information 182.

On the other hand, when the action plan generator 140 determines that the local map information 182 is not available, the action plan generator 140 performs control without using the local map information 182 (step S17). For example, when automated driving control is performed, control for switching to manual driving is performed, and the driver starts manual driving. Further, the action plan generator 140 causes the HMI 30 to display a simple map on the basis of the first map information 54. The action plan generator 140 performs control using the local map information on the basis of an instruction of the user regarding the availability of the local map information 182 generated by the map generator 170. The action plan generator 140 changes whether or not the control using the local map information 182 is performed on the basis of the presence or absence of a passenger in the vehicle M. Now, the process of this flowchart ends.

According to the embodiment described above, it is possible to generate the map information associated with the individual in an arbitrary range by including the recognizer (132) that recognizes a surrounding situation of a vehicle, and the map generator (170) that generates local map information associated with a user on the basis of the surrounding situation recognized by the recognizer and an instruction of the user regarding whether or not a map for each route or road through which the vehicle passes is generated.

### [Hardware Configuration]

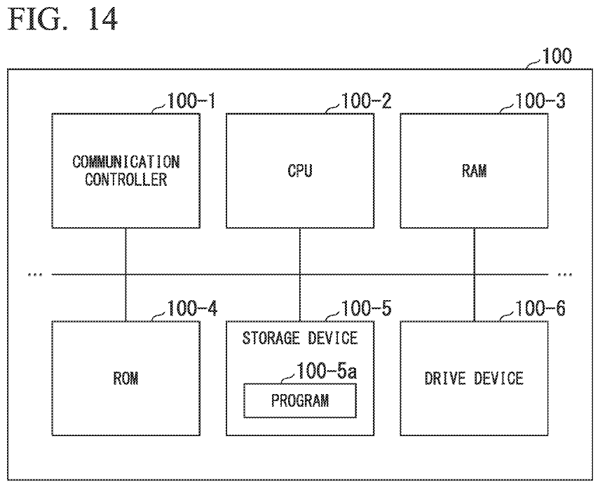

FIG. 14 is a diagram showing an example of a hardware configuration of various control devices. As shown, various control devices have a configuration in which a communication controller 100-1, a CPU 100-2, a RAM 100-3 used as a working memory, a ROM 100-4 that stores a boot program or the like, a storage device 100-5 such as a flash memory or an HDD, a drive device 100-6, and the like are connected to each other by an internal bus or a dedicated communication line. The communication controller 100-1 performs communication with components other than the vehicle control device 100. The storage device 100-5 stores a program 100-5a that is executed by the CPU 100-2. This program is expanded to the RAM 100-3 by a direct memory access (DMA) controller (not shown) or the like, and is executed by the CPU 100-2. Accordingly, some or all of the first controller 120, the second controller 160, and the map generator 170 of the vehicle control device 100, and a map information management device 300 are realized.

The embodiment described above can be represented as follows.

A vehicle control device including

a storage device that stores a program, and

a hardware processor,

wherein the hardware processor is configured to execute the program stored in the storage device to

recognize a surrounding situation of a vehicle, and

generate local map information associated with a user on the basis of the recognized surrounding situation and an instruction of the user regarding whether or not a map for each route or road through which the vehicle passes is generated.

While forms for carrying out the present invention have been described using the embodiments, the present invention is not limited to these embodiments at all, and various modifications and substitutions can be made without departing from the gist of the present invention.

### INDUSTRIAL APPLICABILITY

The vehicle control device of the present invention includes the surroundings recognizer (132) that recognizes a surrounding situation of a vehicle M, and the map generator (170) that generates local map information associated with a user on the basis of the surrounding situation recognized by the recognizer and an instruction of the user regarding whether or not a map for each route or road through which the vehicle passes is generated.

The vehicle control device of the present invention is useful if map information associated with an individual is generated in an arbitrary range.

### REFERENCE SIGNS LIST

1 Vehicle system
10 Camera
12 Radar device
14 Finder
16 Object recognition device
20 Communication device
30 HMI
40 Vehicle sensor
50 Navigation device
51 GNSS receiver
52 Navigation HMI
53 Route determiner
60 MPU
61 Recommended lane determiner
80 Driving operator
100 Vehicle control device
120 First controller
130 Recognizer
132 Surroundings recognizer
140 Action plan generator
160 Second controller
162 Acquirer
164 Speed controller
166 Steering controller
170 Map generator
200 Travel driving force output device
210 Brake device
220 Steering device

What is claim is:

1.-11. (canceled)

12. A vehicle control device comprising a processor configured to execute a program to:
recognize a surrounding situation of a vehicle; and
generate local map information associated with a user on the basis of the recognized surrounding situation and an instruction of the user regarding whether or not a map for each route or road along which the vehicle passes is generated.

13. The vehicle control device according to claim 12, wherein the processor is further configured to execute the program to delete, from the local map information, information indicating at least some routes or roads designated by the user among the routes or roads indicated by the generated local map information.

14. The vehicle control device according to claim 12, wherein the processor is further configured to execute the program to perform control using the local map information on the basis of an instruction of the user regarding availability of the generated local map information.

15. The vehicle control device according to claim 12, wherein the processor is further configured to execute the program to change whether or not the local map information is generated on the basis of the presence or absence of passengers in the vehicle.

16. The vehicle control device according to claim 14, wherein the processor is further configured to execute the program to change whether or not control using the local map information is performed on the basis of the presence or absence of passengers in the vehicle.

17. The vehicle control device according to claim 12, wherein the processor is further configured to execute the program to provide route information with which the local map information is scheduled to be generated after the vehicle ends traveling.

18. The vehicle control device according to claim 12, wherein the processor is further configured to execute the program not to generate the local map information of the vicinity of a home of the user.

19. The vehicle control device according to claim 12, wherein the processor is further configured to execute the program to generate a screen capable of receiving a designation of a route or road for which the local map information is not generated.

20. The vehicle control device according to claim 12, wherein the processor is further configured to execute the program to generate a screen capable of receiving a designation of the route or road to be deleted among the routes or roads indicated by the local map information.

21. A vehicle control method comprising:
recognizing, by a computer, a surrounding situation of a vehicle; and
generating, by the computer, local map information associated with a user on the basis of the recognized surrounding situation and an instruction of the user regarding whether or not a map for each route or road through which the vehicle passes is generated.

22. A non-transitory computer-readable storage medium storing a program causing a computer to:
recognize a surrounding situation of a vehicle; and
generate local map information associated with a user on the basis of the recognized surrounding situation and an instruction of the user regarding whether or not a map for each route or road through which the vehicle passes is generated.
